(19) United States
(12) Patent Application Publication
(10) Pub. No.: US 2024/0253310 A1
(43) Pub. Date: Aug. 1, 2024

(54) Three Dimensional Shaping Device

(71) Applicant: SEIKO EPSON CORPORATION, Tokyo (JP)

(72) Inventor: Masayuki GOZU, Ina (JP)

(21) Appl. No.: 18/422,054

(22) Filed: Jan. 25, 2024

(30) Foreign Application Priority Data
Jan. 26, 2023 (JP) 2023-010119

(51) Int. Cl. B29C 64/35; B29C 64/245; B29C 64/295; B33Y 30/00; B33Y 40/00

(52) U.S. Cl. CPC B29C 64/35; B29C 64/245; B29C 64/295; B33Y 30/00; B33Y 40/00

(57) ABSTRACT

A three dimensional shaping device includes an ejection section that includes a nozzle and configured to eject a shaping material; a stage on which the shaping material is layered; a cleaning section including at least one cleaning member that rotates about a rotation axis; a movement section configured to change relative positions of the ejection section, the stage, and the cleaning section; and a control section. The control section controls the movement section to execute a cleaning operation of bringing the cleaning member and the nozzle into contact with each other while reciprocating the nozzle relative to the cleaning section so that the nozzle passes across the cleaning member a plurality of times and in the cleaning operation, the nozzle comes into contact with the cleaning member at different positions in a forward path and a return path of the nozzle by rotating the cleaning member about the rotation axis.

The present application is based on, and claims priority from JP Application Serial Number 2023-010119, filed Jan. 26, 2023, the disclosure of which is hereby incorporated by reference herein in its entirety.

### BACKGROUND

### 1. Technical Field

The present disclosure relates to a three dimensional shaping device.

### 2. Related Art

JP-T-2010-530326 discloses a three dimensional shaping device including an end section cleaning assembly having a flicker plate and a brush. In the three dimensional shaping device, cleaning of an extrusion head is performed by bringing the extrusion head into contact with the flicker plate and the brush.

When cleaning is performed by reciprocating a tip end of the head with respect to a cleaning mechanism such as a flicker plate or a brush, waste material clinging to the cleaning mechanism may be re-deposited on the head and affect the shaping accuracy.

### SUMMARY

According to one aspect of the present disclosure, a three dimensional shaping device is provided.

The three dimensional shaping device includes an ejection section that includes a nozzle having a nozzle opening and that is configured to eject a shaping material from the nozzle opening; a stage on which the shaping material is layered; a cleaning section including at least one cleaning member that rotates about a rotation axis; a movement section configured to change relative positions of the ejection section, the stage, and the cleaning section; and a control section. The control section controls the movement section to execute a cleaning operation of bringing the cleaning member and the nozzle into contact with each other while reciprocating the nozzle relative to the cleaning section so that the nozzle passes across the cleaning member a plurality of times. In the cleaning operation, the nozzle comes into contact with the cleaning member at different positions in a forward path and a return path of the nozzle by rotating the cleaning member about the rotation axis.

### BRIEF DESCRIPTION OF THE DRAWINGS

FIG. 1 is a first explanatory view showing a schematic configuration of a three dimensional shaping device.

FIG. 2 is a second explanatory view showing a schematic configuration of the three dimensional shaping device.

FIG. 3 is a perspective view showing a schematic configuration of a screw.

FIG. 4 is a schematic plan view of a barrel.

FIG. 5 is a perspective view of a cleaning mechanism.

FIG. 6 is a perspective view of a cleaning section.

FIG. 7 is a cross-sectional view taken along line VII-VII of FIG. 6.

FIG. 8 is a view for explaining arrangements of cleaning members.

FIG. 9 is a front view of the cleaning section.

FIG. 10 is a cross-sectional view of a mount section.

FIG. 11 is a flowchart of a cleaning process.

FIG. 12 is a view for explaining a height adjustment process.

FIG. 13 is a view for explaining an example of arrangements of cleaning members according to another embodiment.

### DESCRIPTION OF EMBODIMENTS

### A. First Embodiment

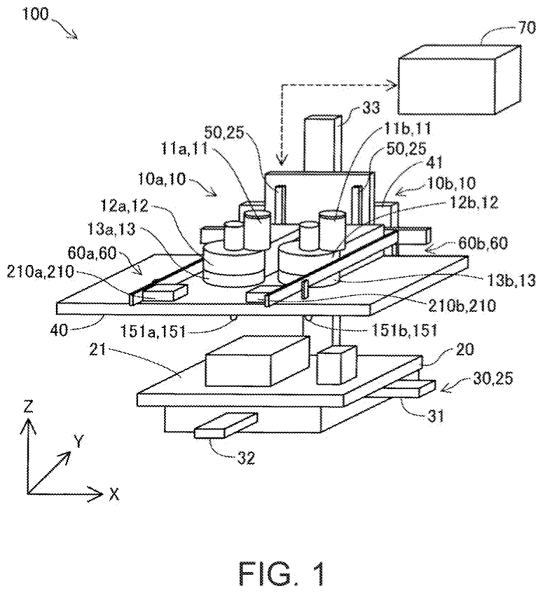

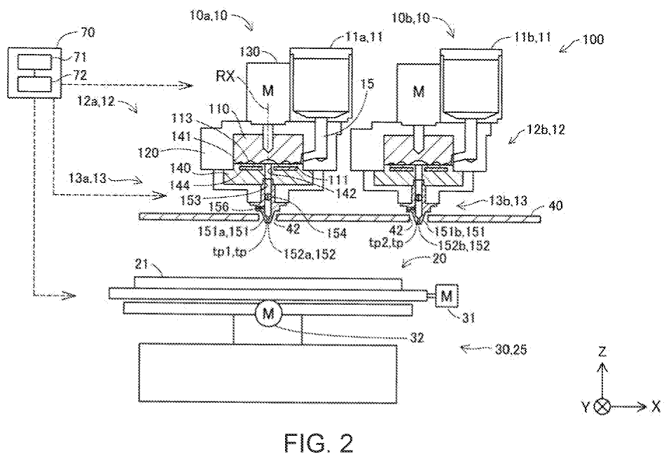

FIGS. 1 and 2 are explanatory views showing a schematic configuration of a three dimensional shaping device 100 according to a first embodiment. FIGS. 1 and 2 show arrows indicating X, Y, and Z directions orthogonal to each other. The X direction and the Y direction are directions parallel to a horizontal plane, and the Z direction is a direction along a vertically upward direction. The arrows indicating the X, Y, and Z directions are appropriately shown in other drawings so that the directions shown in the drawings correspond to FIGS. 1 and 2. In the following description, when a direction is specified, a direction indicated by an arrow in each drawing is referred to as “+” and an opposite direction is referred to as “−”, and positive and negative signs are used in combination for direction notation. Hereinafter, the +Z direction is also referred to as “upper”, and the −Z direction is also referred to as “lower”.

The three dimensional shaping device 100 of the present embodiment is a device that shapes a shaped object by a material extrusion method. The three dimensional shaping device 100 includes heads 10 including nozzles 151, a stage 20, a movement section 25, a heating section 40, head raising/lowering mechanisms 50, cleaning mechanisms 60 each including a cleaning section 220, and a control section 70. In FIG. 2, the cleaning mechanisms 60 are omitted.

The control section 70 is a control device that controls operation of the entire three dimensional shaping device 100. As shown in FIG. 2, the control section 70 is composed of a computer including a CPU 71, a storage device 72, and an input/output interface for inputting and outputting signals to and from the outside. The control section 70 exhibits various functions such as a function of executing a shaping process for shaping a three dimensional shaped object and a function of executing a cleaning process (to be described later) by the CPU 71 executing a program or a command read into a main storage device. In another embodiment, the control section 70 may be realized by a combination of a plurality of circuits for realizing at least a part of each function, instead of being constituted by a computer.

In the shaping process, the control section 70 shapes the three dimensional shaped object in accordance with shaping data for shaping the three dimensional shaped object. The shaping data includes, for each layer obtained by slicing a shape of a shaped object into a plurality of layers, path information indicating a movement path of the nozzle 151 and ejecting amount information indicating the ejecting amount of a plasticized material in each movement path.

The heads 10 shown in FIGS. 1 and 2 ejects a shaping material for shaping a three dimensional shaped object onto the stage 20 serving as a basal section of the three dimensional shaped object under the control of the control section 70. In the present embodiment, the shaping material is a plasticized material obtained by plasticizing a material in a solid state into a paste state, as will be described later. The head 10 includes a material supply section 11, a plasticizing section 12, and an ejection section 13.

A three dimensional shaping device 100 includes a first head 10a and a second head 10b as the heads 10. The first head 10a includes a first material supply section 11a as the material supply section 11, a first plasticizing section 12a as the plasticizing section 12, and a first ejection section 13a as the ejection section 13. The second head 10b includes a second material supply section 11b as the material supply section 11, a second plasticizing section 12b as the plasticizing section 12, and a second ejection section 13b as the ejection section 13. The first head 10a and the second head 10b are arranged side by side in the X direction so that their positions in the Y direction coincide with each other. The second head 10b is arranged on a +X direction side of the first head 10a. Since the configuration of the first head 10a is the same as that of the second head 10b, the first head 10a and the second head 10b may be simply referred to as the head 10 in the following description unless they are distinguished from each other. In a case where the constituent members of both heads are distinguished from each other, the constituent members of the first head 10a are denoted by a reference symbol “a”, and the constituent members of the second head 10b are denoted by a reference symbol “b”.

The material supply section 11 supplies a material for generating a shaping material to the plasticizing section 12. The material supply section 11 is constituted by, for example, a hopper. The material supply section 11 accommodates a pellet-shaped or powder material. As the material, for example, a thermoplastic resin such as a polypropylene (PP) resin, a polyethylene (PE) resin, or a polyoxymethylene (POM) resin is used. The material accommodated in the first material supply section 11a and the material accommodated in the second material supply section 11b may be the same type of material or different types of materials.

A communication path 15 that connects the material supply section 11 and the plasticizing section 12 is provided below the material supply section 11. The material supply section 11 supplies the material to the plasticizing section 12 via the communication path 15.

The plasticizing section 12 plasticizes at least a part of the material supplied from the material supply section 11, generates a pasty shaping material having fluidity, and guides the shaping material to the ejection section 13. “Plasticization” is a concept including melting, and is a change from a solid to a state having fluidity. Specifically, in the case of a material in which glass transition occurs, plasticization means that the temperature of the material is set to be equal to or higher than the glass transition point. In the case of a material that does not undergo glass transition, plasticization refers to raising the temperature of the material above its melting point.

The plasticizing section 12 includes a screw 110, a screw case 120, a drive motor 130, and a barrel 140.

The screw 110 is housed in a screw case 120. The upper surface side of the screw 110 is coupled to the drive motor 130. The screw 110 is rotated in the screw case 120 by rotational driving force generated by the drive motor 130. An axial direction of a screw rotation axis RX, which is a rotation axis of the screw 110, is the Z direction. The rotational speed of the screw 110 is controlled by the control section 70 controlling the rotational speed of the drive motor 130. The screw 110 may be driven by the drive motor 130 via a decelerator. The screw 110 is also referred to as a rotor or a flat screw.

The barrel 140 is arranged on a −Z direction side of the screw 110. A facing surface 141, which is an upper surface of the barrel 140, faces a groove forming surface 111, which is a lower surface of the screw 110. A communication hole 142 communicating with a flow path 153 of the ejection section 13 is formed in the center of the barrel 140. A plasticizing heater 144 is provided inside the barrel 140. The temperature of the plasticizing heater 144 is controlled by the control section 70.

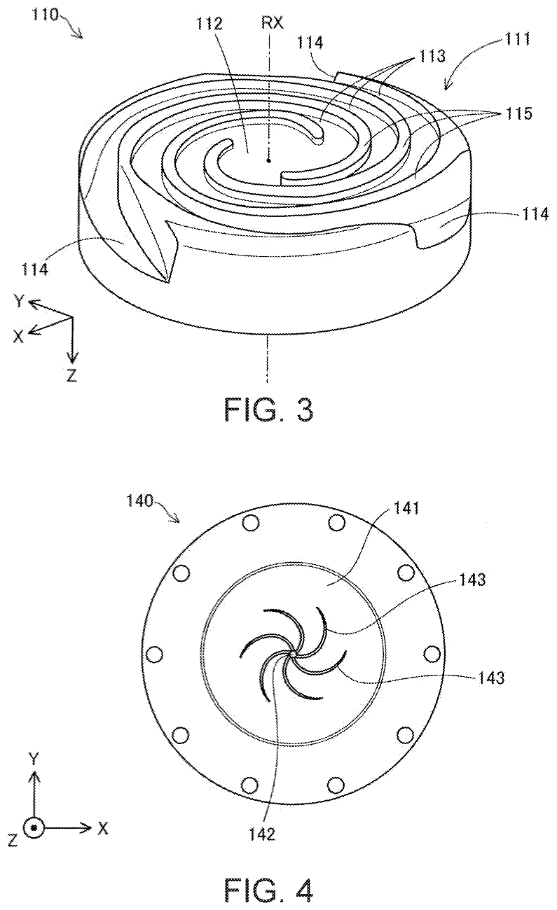

FIG. 3 is a perspective view showing a schematic configuration of the screw 110. The screw 110 has a substantially cylindrical shape whose length in a direction along the screw rotation axis RX is smaller than the length in a direction perpendicular to the screw rotation axis RX. On the groove forming surface 111, spiral grooves 113 are formed around a central section 112. The grooves 113 communicate with a material input port 114 formed in a side surface of the screw 110. The material supplied from the material supply section 11 is supplied to the grooves 113 through the material input port 114. The grooves 113 are formed by being separated from each other by ridge sections 115. FIG. 3 shows an example in which three grooves 113 are formed, but the number of grooves 113 may be one, two, or more. The grooves 113 are not limited to a spiral shape, but may be a helix or an involute curve shape, or may extend in an arc from the central section 112 to the outer periphery.

FIG. 4 is a schematic plan view of the barrel 140. A plurality of guide grooves 143 are formed around the communication hole 142 in the facing surface 141. Each of the guide grooves 143 has one end connected to the communication hole 142 and extends in a spiral shape from the communication hole 142 toward the outer periphery of the facing surface 141. One end of the guide grooves 143 may not be connected to the communication hole 142. The guide grooves 143 may not be formed in the barrel 140.

The material supplied to the grooves 113 of the screw 110 flows along the grooves 113 while being plasticized in the grooves 113 by the rotation of the screw 110 and the heat of the plasticizing heater 144, and is guided to the central section 112 of the screw 110 as a shaping material. The pasty shaping material exhibiting fluidity that has flowed into the central section 112 is supplied to the ejection section 13 via the communication hole 142. The plasticizing section 12 may not plasticize all types of substances constituting the shaping material. The shaping material may be converted into a state having fluidity as a whole by plasticizing at least some kinds of substances among substances constituting the shaping material.

The ejection section 13 ejects the shaping material. The ejection section 13 includes the nozzle 151, the flow path 153, an ejection adjustment section 154, and a suction section 156.

The nozzle 151 is connected to the communication hole 142 of the barrel 140 through the flow path 153. The nozzle 151 ejects the shaping material generated in the plasticizing section 12 toward the stage 20 from a nozzle opening 152, which is an opening formed in the tip end section tp of the nozzle 151. Specifically, the first nozzle 151a ejects the shaping material from a first nozzle opening 152a formed in a first tip end section tp1. The second nozzle 151b ejects the shaping material from a second nozzle opening 152b formed in a second tip end section tp2.

The ejection adjustment section 154 is provided in the flow path 153, and adjusts the opening degree of the flow path 153. In the present embodiment, the ejection adjustment section 154 is constituted by a butterfly valve, and changes an opening area of the flow path 153 by rotating in the flow path 153. The ejection adjustment section 154 is driven by a drive section (not shown) under the control of the control section 70. The drive section that drives the ejection adjustment section 154 is constituted by, for example, a stepper motor. The control section 70 can adjust the flow rate of the shaping material flowing from the plasticizing section 12 to the nozzle 151, that is, the ejecting amount of the shaping material ejected from the nozzle 151, by controlling the rotation angle of the butterfly valve. The ejection adjustment section 154 can adjust the ejecting amount of the shaping material and can control ON/OFF of the outflow of the shaping material. The shape of the butterfly valve is not limited as long as it rotates in the flow path 153 to adjust the opening degree of the flow passage 153, and may be, for example, a plate shape or a hemispherical shape. In another embodiment, the ejection adjustment section 154 may be configured as, for example, a piston mechanism that adjusts the opening degree of the flow path 153 by the operation of a piston, or a shutter mechanism that adjusts the opening degree of the flow path 153 by opening and closing a shutter.

The suction section 156 is connected between the ejection adjustment section 154 and the nozzle opening 152 in the flow path 153. The suction section 156 suppresses a tailing phenomenon in which a shaping material drips from the nozzle opening 152 in a thread-like manner, by temporarily sucking the shaping material in the flow path 153 at the time of stopping the ejection of the shaping material from the nozzle 151. The suction section 156 is constituted by a plunger. The suction section 156 is controlled by the control section 70. The suction section 156 is driven by a drive section (not shown) under the control of the control section 70. The drive section for driving the suction section 156 is constituted by, for example, a stepper motor, a rack and pinion mechanism for converting a rotational force of the stepper motor into a translational motion of the plunger, or the like.

The stage 20 is arranged at a position facing the nozzle opening 152 of the nozzle 151. The three dimensional shaping device 100 shapes a three dimensional shaped object by ejecting a shaping material from the nozzle 151 to a shaping surface 21, which is an upper surface of the stage 20, and layering shaped layers. The region on the shaping surface 21 in which the three dimensional shaped object is shaped is also referred to as a shaping region. A direction in which the shaping material is layered on the shaping surface 21 is also referred to as a layering direction.

The movement section 25 changes the relative positions of the ejection section 13, the stage 20, and the cleaning section 220. As shown in FIG. 1, the movement section 25 according to the present embodiment includes a position changing section 30, the head raising/lowering mechanisms 50, and cleaning movement sections 210.

The position changing section 30 changes the relative positions of the ejection section 13 and the stage 20 without changing the relative positional relationship between the ejection section 13 and the cleaning mechanism 60. Specifically, the position changing section 30 includes a first electric actuator 31 for moving the stage 20 in the X direction, a second electric actuator 32 for moving the stage 20 and the first electric actuator 31 in the Y direction, and a third electric actuator 33 for moving the head 10 in the Z direction. The third electric actuator 33 moves the first head 10a, the second head 10b, and the cleaning mechanisms 60 in the Z direction by moving a movable section 41, to which the first head 10a, the second head 10b, and the cleaning mechanisms 60 are fixed, in the Z direction. The first electric actuator 31, the second electric actuator 32, and the third electric actuator 33 are driven under the control of the control section 70. In FIG. 2, the third electric actuator 33 and the movable section 41 are omitted.

In another embodiment, for example, the position changing section 30 may move the stage 20 in the Z direction and move the first head 10a and the second head 10b along the X direction and the Y direction, may move the stage 20 in the X direction, the Y direction, and the Z direction without moving the first head 10a and the second head 10b, or may move the first head 10a and the second head 10b in the X direction, the Y direction, and the Z direction without moving the stage 20.

The head raising/lowering mechanism 50 moves the head 10 in the Z direction with respect to the cleaning section 220. When the head 10 is moved by the head raising/lowering mechanism 50, the relative position of the ejection section 13 and the stage 20 in the Z direction is also changed in addition to the relative position of the ejection section 13 and the cleaning section 220 in the Z direction. The three dimensional shaping device 100 is provided with two head raising/lowering mechanisms 50 corresponding to the first head 10a and the second head 10b. In the present embodiment, one head raising/lowering mechanism 50 moves the first head 10a in the Z direction, and the other head raising/lowering mechanism 50 moves the second head 10b in the Z direction. Each head raising/lowering mechanism 50 is fixed to the movable section 41, and is moved in the Z direction by the third electric actuator 33 together with the head 10 and the cleaning mechanism 60. Each head raising/lowering mechanism 50 is configured as, for example, an electric actuator, and is individually driven under the control of the control section 70. In FIG. 2, the head raising/lowering mechanism 50 is omitted.

The cleaning movement section 210 moves the cleaning section 220 with respect to the nozzle 151. In this embodiment, the three dimensional shaping device 100 is provided with two cleaning movement sections 210 corresponding to the first nozzle 151a and the second nozzle 151b. The cleaning movement section 210 will be described in detail later.

The heating section 40 heats the shaping material layered on the stage 20. The heating section 40 has a plate shape and includes a heater. The heating section 40 is fixed to the movable section 41 such that the surface direction thereof is along a surface direction of the shaping surface 21. As shown in FIG. 2, the heating section 40 is provided with openings 42 penetrating the heating section 40 in the Z direction. Specifically, the heating section 40 is provided with two openings 42 corresponding to the first nozzle 151a and the second nozzle 151b.

The heating section 40 is configured such that the relative position with respect to the stage 20 is changed together with the first head 10a and the second head 10b. Specifically, in the present embodiment, the heating section 40 is fixed to the movable section 41, and is moved in the Z direction together with the heads 10 by the third electric actuator 33. Therefore, it can also be said that the movement section 25 in the present embodiment moves the heating section 40 and the cleaning section 220 relative to the stage 20 together with the ejection section 13 under the control of the control section 70.

In the present embodiment, each of the first nozzle 151a and the second nozzle 151b is configured to be capable of switching between a shaping state and a retreated state by the head raising/lowering mechanism 50. The shaping state refers to a state in which the nozzle opening 152 is arranged between the heating section 40 and the stage 20 in the Z direction. In the shaping state, at least a portion of the nozzle 151 is arranged within the opening 42. The nozzle 151 is in a shaping state at least at the time of shaping. The time of shaping refers to the timing at which the shaping material is ejected to the shaping region in order to shape shaped layers. In FIGS. 1 and 2, the first nozzle 151a and the second nozzle 151b are in the shaping state. The retreated state refers to a state in which the nozzle opening 152 is arranged above the heating section 40. In the retreated state, the nozzle 151 is arranged outside the opening 42. The head raising/lowering mechanism 50 moves the head 10 in the +Z direction when switching the nozzle 151 from the shaping state to the retreated state, and moves the head 10 in the −Z direction when switching the nozzle 151 from the retreated state to the shaping state.

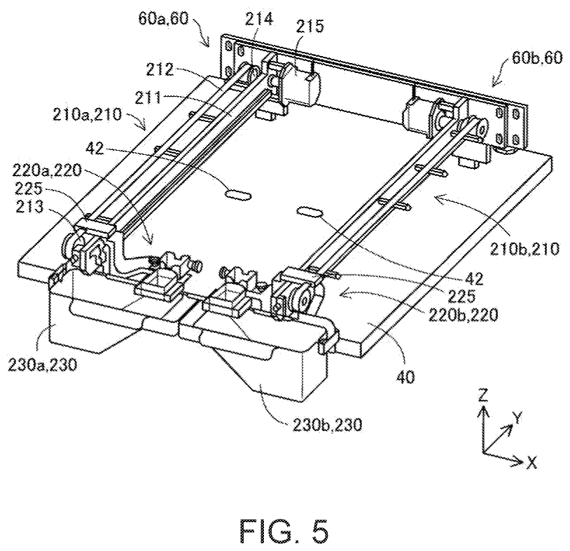

FIG. 5 is a perspective view of the cleaning mechanism 60. In the present embodiment, the cleaning mechanism 60 is fixed to the heating section 40, and is moved in the Z direction together with the heating section 40 by the third electric actuator 33.

The cleaning mechanism 60 includes the cleaning movement section 210, the cleaning section 220, and a waste material accommodation section 230. In the present embodiment, the cleaning mechanism 60 includes a first cleaning mechanism 60a and a second cleaning mechanism 60b. The first cleaning mechanism 60a includes a first cleaning movement section 210a as the cleaning movement section 210, a first cleaning section 220a as the cleaning section 220, and a first waste material accommodation section 230a as the waste material accommodation section 230. The second cleaning mechanism 60b includes a second cleaning movement section 210b as the cleaning movement section 210, a second cleaning section 220b as the cleaning section 220, and a second waste material accommodation section 230b as the waste material accommodation section 230. The first cleaning mechanism 60a performs cleaning of the first nozzle 151a and the second cleaning mechanism 60b performs cleaning of the second nozzle 151b. The configurations of the first cleaning mechanism 60a and the second cleaning mechanism 60b are the same. When the constituent members of the first cleaning mechanism 60a and the second cleaning mechanism 60b are distinguished from each other, the constituent members of the first cleaning mechanism 60a are denoted by a reference symbol “a”, and the constituent members of the second cleaning mechanism 60b are denoted by a reference symbol “b”.

The cleaning movement section 210 moves the cleaning section 220 relative to the nozzle 151. The cleaning movement section 210 is fixed to an upper surface of the heating section 40. The cleaning movement section 210 includes a guide frame 211, a drive belt 212, a first reel 213, a second reel 214, and a belt drive section 215. The guide frame 211 is provided along the Y direction. The first reel 213 is provided at a −Y direction side end section of the guide frame 211. The second reel 214 is provided at a +Y direction side end section of the guide frame 211. The drive belt 212 is wound around the first reel 213 and the second reel 214, one end of which is wound around the first reel 213 and the other end of which is wound around the second reel 214. The belt drive section 215 winds up or unwinds the drive belt 212 by rotationally driving the first reel 213 and the second reel 214. The belt drive section 215 is constituted by a motor, for example, and is controlled by the control section 70.

The cleaning section 220 is arranged above the heating section 40, and is coupled to the cleaning movement section 210 via a coupling section 225. The coupling section 225 fixes the cleaning section 220 to the drive belt 212 by sandwiching and fixing the drive belt 212. The coupling section 225 is attached to the guide frame 211 so that the cleaning section 220 can be moved in the Y direction. Therefore, the cleaning section 220 moves in the Y direction along the guide frame 211 as the drive belt 212 is wound on or unwound from the first reel 213 and the second reel 214. With this configuration, the cleaning section 220 is moved relative to the stage 20 by the position changing section 30 together with the nozzle 151, and is moved relative to the nozzle 151 by the cleaning movement section 210. In the present embodiment, the relative positional relationship between the cleaning section 220 and the heating section 40 in the Z direction is fixed. Therefore, in the present embodiment, the heating section 40 is positioned above the nozzle opening 152 and below the cleaning section 220 at the time of shaping.

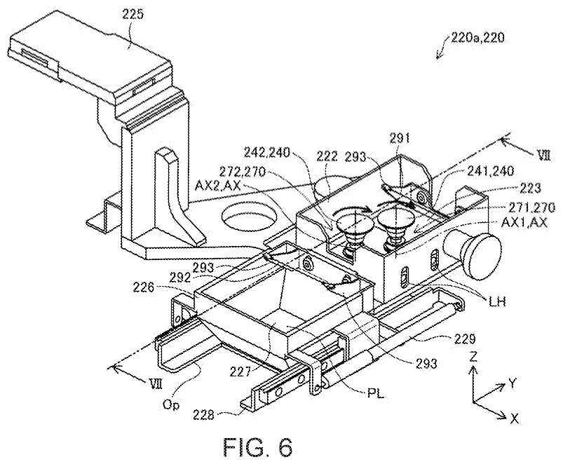

FIG. 6 is a perspective view of the cleaning section 220. Specifically, FIG. 6 shows the first cleaning section 220a. The cleaning section 220 includes cleaning members 240, a cleaning box 222, a purge section 226, a first cut section 291, and a second cut section 292.

The cleaning members 240 are members for cleaning the nozzle 151. The cleaning members 240 remove foreign matter clinging to the nozzle 151 by contact between the cleaning members 240 and the nozzle 151. In the present embodiment, each cleaning section 220 includes two cleaning members 240. Hereinafter, one of the cleaning members 240 included in the first cleaning section 220a is also referred to as a first cleaning member 241, and the other is also referred to as a second cleaning member 242.

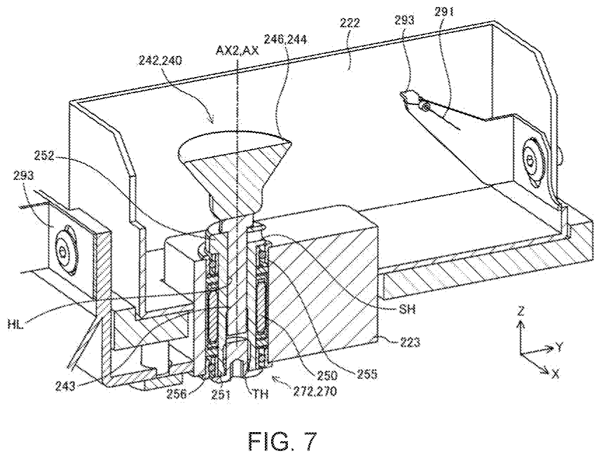

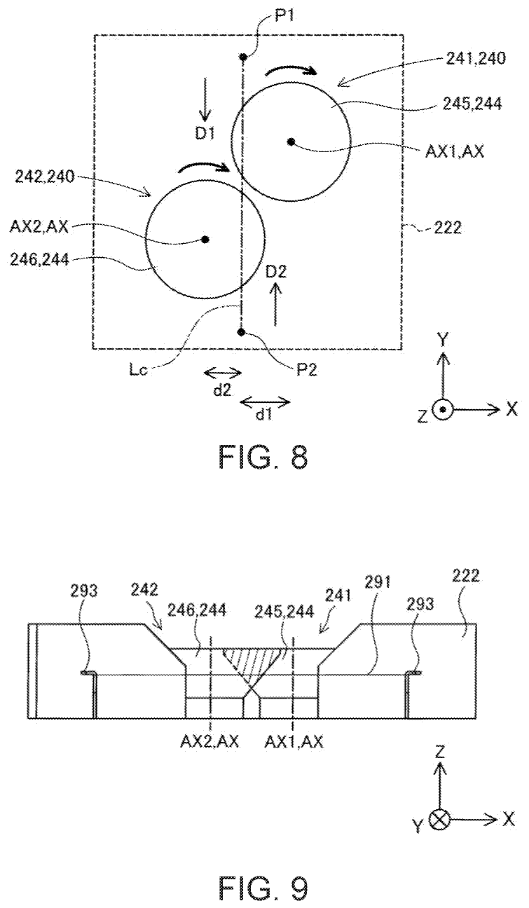

FIG. 7 is a cross-sectional view taken along line VII-VII of FIG. 6. In FIG. 7, some of the components of the cleaning section 220 are appropriately omitted. FIGS. 6 and 7 schematically show the shape of the cleaning member 240. Similarly, the cleaning member 240 is schematically shown in FIG. 8 and subsequent drawings described later. In the present embodiment, the cleaning member 240 is configured as a brush having an overall shaft shape. As shown in FIGS. 6 and 7, the cleaning member 240 includes a shaft-shaped handle section 243 and a contact member 244 provided at one end section of the handle section 243 in an axial direction. The contact member 244 is configured as bristles of a brush and is made of stainless steel. The contact member 244 extends outward from one end section of the handle section 243 in the axial direction of the handle section 243. The contact member 244 is arranged in a circular shape as a whole when viewed in the axial direction of the handle section 243. In the present embodiment, the cleaning member 240 is arranged so that the handle section 243 extends along the Z direction and a tip end of the contact member 244, that is, the bristle tip, faces upward. In other embodiments, the contact member 244 may not be formed of stainless steel, and may be formed of, for example, a metal such as steel or brass, or a resin such as nylon or polyester. The contact member 244 may not be arranged in a circular shape when viewed in the axial direction of the handle section 243, but may be arranged in, for example, a polygonal shape or an elliptical shape. Hereinafter, the contact member 244 of the first cleaning member 241 is also referred to as a first contact member 245, and the contact member 244 of the second cleaning member 242 is also referred to as a second contact member 246.

As described later, the cleaning member 240 is configured to be rotatable about a rotation axis AX. In the present embodiment, the cleaning member 240 rotates about the rotation axis AX with the center axis of the handle section 243 as the rotation axis AX. Hereinafter, the rotation axis AX of the first cleaning member 241 is also referred to as a first rotation axis AX1, and the rotation axis AX of the second cleaning member 242 is also referred to as a second rotation axis AX2.

As shown in FIG. 6, the cleaning box 222 has a box shape with an opening at the top. The cleaning member 240 in the present embodiment is attached to a base 223 arranged in the cleaning box 222 so as to be rotatable about the rotation axis AX. The attachment of the cleaning member 240 to the base 223 will be described later in detail. The base 223 is fastened to a side surface of the cleaning box 222 by screws (not shown) via elongated holes LH formed along the Z direction in a side wall of the cleaning box 222. Therefore, the height of the base 223 with respect to the cleaning box 222 can be changed by the elongated holes LH and the screws. By changing the height of the base 223, the position of the contact member 244 of each cleaning member 240 in the Z direction is changed.

FIG. 8 is a view for explaining arrangements of the cleaning members 240. FIG. 9 is a front view of the cleaning section 220. In FIG. 8, an outer edge of the cleaning box 222 is schematically indicated by broken line. In FIG. 9, some of the components of the cleaning section 220 are appropriately omitted. As shown in FIG. 8, the first rotation axis AX1 is arranged at a position on a +X direction side and a +Y direction side of the second rotation axis AX2. As shown in FIG. 9, the first cleaning member 241 and the second cleaning member 242 are arranged such that the positions of the tips of the contact members 244 of the cleaning members 240 in the Z direction are substantially the same. When viewed along the Y direction, at least a part of the first contact member 245 and at least a part of the second contact member 246 overlap each other between the first rotation axis AX1 and the second rotation axis AX2. In FIG. 9, the portions where the contact members 244 of the cleaning members 240 overlap each other are hatched.

As shown in FIGS. 6 and 7, in the present embodiment, the base 223 is provided with mount sections 270 for mounting the cleaning members 240 to the base 223 so as to correspond to the cleaning members 240. The cleaning members 240 are detachably attached to the mount sections 270. Hereinafter, the mount section 270 for mounting the first cleaning member 241 is also referred to as a first mount section 271, and the mount section 270 for mounting the second cleaning member 242 is also referred to as a second mount section 272.

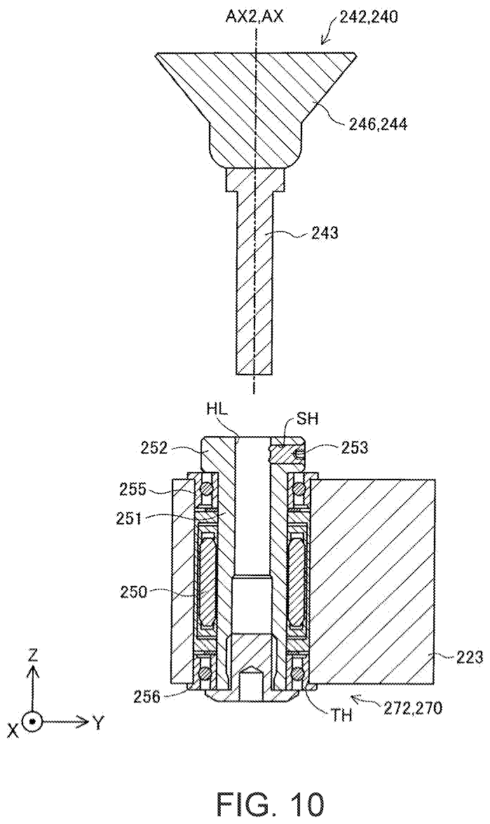

FIG. 10 is a cross-sectional view of the mount section 270. Specifically, FIG. 10 shows the second mount section 272 as the mount section 270. As shown in FIGS. 7 and 10, the mount section 270 includes a restriction section 250. The restriction section 250 restricts rotation of the cleaning member 240 about the rotation axis AX in one direction and allows rotation in the other direction. When viewed in the −Z direction, the restriction section 250 in the present embodiment allows the cleaning member 240 to rotate in a right direction and restricts the cleaning member 240 from rotating in a left direction. In the following description, unless otherwise specified, when a rotational direction of the cleaning member 240 is referred to as the left direction or the right direction, it means the rotational direction when viewed in the −Z direction. In the present embodiment, a direction in which the first cleaning member 241 is allowed to rotate and a direction in which the second cleaning member 242 is allowed to rotate are the same left direction.

As shown in FIGS. 7 and 10, in addition to the restriction section 250 described above, the mount section 270 in the present embodiment includes a pipe section 251, a first bearing 255, and a second bearing 256.

The pipe section 251 has a substantially cylindrical shape as a whole. One end section of the pipe section 251 is configured as a flange section 252 having a flange shape. The pipe section 251 is arranged in a through hole TH formed in the base 223 so that the axial direction thereof is along the Z direction. The flange section 252 is arranged above the through hole TH. A screw hole SH is formed in the flange section 252 along a radial direction of the pipe section 251 to communicate a hollow section HL within the pipe section 251 with the outside. A set screw 253 for fixing the cleaning member 240 inserted into the pipe section 251 is arranged in the screw hole SH. In FIG. 7, the set screw 253 is omitted.

The restriction section 250 in the present embodiment is constituted by a cam type one way clutch. The first bearing 255 and the second bearing 256 are configured by, for example, a ball bearing or a roller bearing. The restriction section 250, the first bearing 255, and the second bearing 256 are arranged between the pipe section 251 and an inner wall surface of the through hole TH, and axially support the pipe section 251. Specifically, the first bearing 255 is arranged on a lower side of the flange section 252, and axially supports an upper end section of the pipe section 251. The second bearing 256 axially supports a lower end section of the pipe section 251. The restriction section 250 axially supports a central section of the pipe section 251 between the first bearing 255 and the second bearing 256. When viewed in the −Z direction, the restriction section 250 is arranged so that the inner ring thereof does not rotate in the left direction but rotates in the right direction. With this configuration, when the pipe section 251 is viewed in the −Z direction, rotation in the right direction is allowed in the through hole TH, and rotation in the left direction is restricted. The direction in which rotation of the pipe section 251 is allowed can be easily reversed by arranging the restriction section 250 in the present embodiment upside down. In another embodiment, the restriction section 250 may be constituted by, for example, a one way clutch of a sprag type or a ratchet mechanism.

The cleaning member 240 is mounted on the mount section 270 by being fixed to the pipe section 251 by the set screw 253 in a state where the handle section 243 is inserted into the pipe section 251. The cleaning member 240 mounted on the mount section 270 is allowed to rotate in the right direction together with the pipe section 251, while being restricted from rotating in the left direction. The cleaning member 240 is removed from the mount section 270 by pulling out the handle section 243 upward from the through hole TH as shown in FIG. 10 in a state where the set screw 253 is loosened. In the present embodiment, the attachment height of each cleaning member 240 can be adjusted individually by changing a fixing position of the handle section 243 in the Z direction by the set screw 253.

The purge section 226 shown in FIG. 6 receives a waste material discharged from the nozzle 151. The waste material is shaping material that was ejected from the nozzle 151 to the outside and that does not contribute to the shaping of the three dimensional shaped object. In the present embodiment, the purge section 226 is provided adjacent to the cleaning box 222 on a −Y direction side of the cleaning box 222. The purge section 226 is in the shape of a box including an opening at the top. The purge section 226 may not have a box shape as long as it can receive the shaping material discharged from the nozzle 151, and may have, for example, a flat plate shape or a table shape in other embodiments.

A bottom surface 227 of the purge section 226 is configured to be openable and closable. In the present embodiment, the bottom surface 227 is normally closed, and when the purge section 226 is moved to a position above the waste material accommodation section 230, the bottom surface 227 is opened by the waste material accommodation section 230. Specifically, the bottom surface 227 is opened and closed by the operation of a slide member 228 that slides in the Y direction. The slide member 228 is normally biased in the −Y direction by a spring 229, and as shown in FIG. 6, a plate section PL of the slide member 228 is positioned below the purge section 226. In this state, since the plate section PL constitutes the bottom surface 227 of the purge section 226, the bottom surface 227 is in a closed state. The purge section 226 is in the closed state as described above, for example, when receiving the waste material discharged from the nozzle 151. The slide member 228 is configured so as to be pushed in the +Y direction by a part of the waste material accommodation section 230 when the purge section 226 is moved in the −Y direction to a position above the waste material accommodation section 230 by the cleaning movement section 210. As a result, the plate section PL moves in the +Y direction, and an opening section Op provided adjacent to the −Y direction side of the plate section PL is positioned on a lower side of the purge section 226, so that the bottom surface 227 is in an open state. When contact between the slide member 228 and the waste material accommodation section 230 is released by movement of the purge section 226 in the +Y direction, the bottom surface 227 returns to the closed state.

The first cut section 291 and the second cut section 292 are made of stainless steel wire. The first cut section 291 and the second cut section 292 in the present embodiment are stretched in the X direction by a pair of support arms 293. The first cut section 291 and the second cut section 292 are arranged so as to sandwich the first cleaning member 241 and the second cleaning member 242 therebetween in the Y direction. The first cut section 291 is arranged on a +Y direction side of the first cleaning member 241 in the cleaning box 222. The second cut section 292 is arranged on the −Y direction side of the second cleaning member 242, more specifically, above the purge section 226. In the present embodiment, the first cut section 291 and the second cut section 292 are arranged at substantially the same position in the Z direction. Specifically, as shown in FIG. 9, the first cut section 291 and the second cut section 292 are arranged at a position lower than tip ends of the contact members 244 of the cleaning members 240. In other embodiments, the first cut section 291 and the second cut section 292 may not be made of stainless steel, but may be made of, for example, steel, titanium, brass, or the like.

As will be described later, each of the first cut section 291 and the second cut section 292 is used to cut and remove the shaping material hanging down in a thread shape from the nozzle opening 152. When the first cut section 291 and the second cut section 292 is made of a wire, the pressure at a contact portion between the first cut section 291 or the second cut section 292 and the hanging shaping material can be increased, and the shaping material can be more effectively cut, as compared with the case where the first cut section 291 and the second cut section 292 is made of a plate-shaped member, for example. Since the amount of the shaping material clinging to the first cut section 291 and the second cut section 292 can be reduced, the maintainability of the first cut section 291 and the second cut section 292 can be improved.

The waste material accommodation section 230 shown in FIG. 5 accommodates the shaping material discharged from the nozzle 151 to the purge section 226. The waste material accommodation section 230 is detachably attached to an end section of the heating section 40 on a −Y direction side. The waste material accommodation section 230 has a box shape with an open top. When the shaping material is collected from the purge section 226 to the waste material accommodation section 230, the purge section 226 is moved to a position above the waste material accommodation section 230 by the cleaning movement section 210. When the purge section 226 is moved, the bottom surface 227 is opened by the operation of the slide member 228 described above, so that the shaping material in the purge section 226 falls into the waste material accommodation section 230.

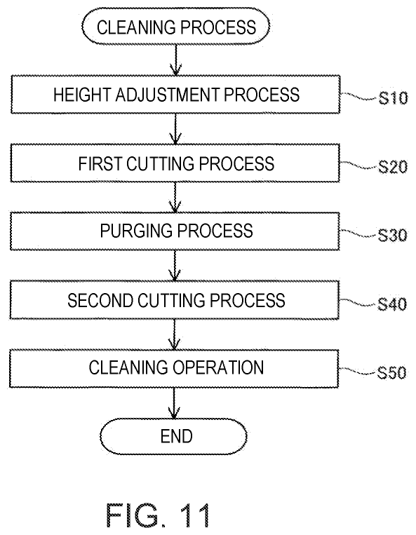

FIG. 11 is a flowchart of a cleaning process executed in the three dimensional shaping device 100. In the present embodiment, the cleaning process is executed at a predetermined timing during shaping of the three dimensional shaped object. The timing at which the cleaning process is executed may be determined based on, for example, the elapsed time during the shaping, the number of shaped layers, or the amount of the shaping material ejected from the nozzle 151. The timing at which the cleaning process is executed may be determined for each nozzle 151.

In step S10, the control section 70 executes a height adjustment process of adjusting the height of the nozzle 151 to be cleaned. In the following description of the cleaning process, the nozzle 151 refers to the “nozzle 151 to be cleaned” unless otherwise specified.

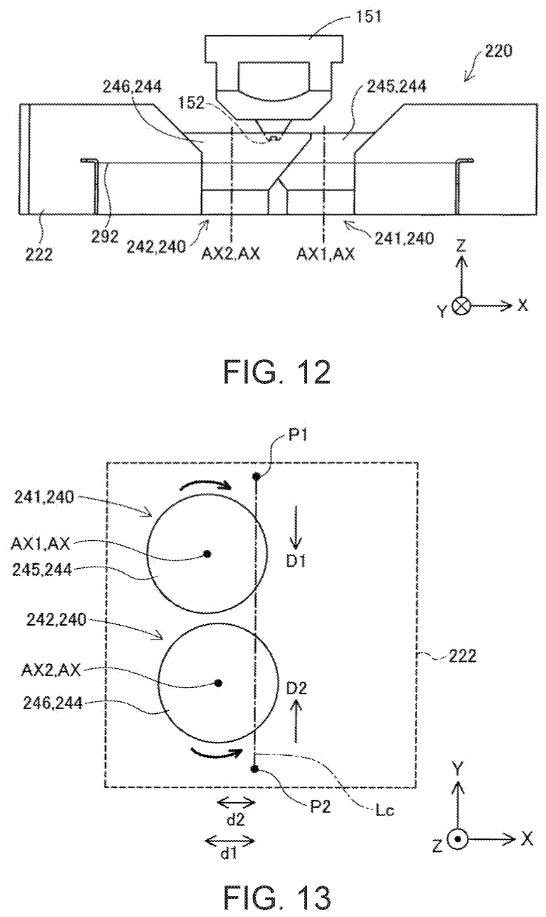

FIG. 12 is a view for explaining the height adjustment process. In the height adjustment process, the control section 70 controls the head raising/lowering mechanism 50 to bring the nozzle 151 into the retreated state. The control section 70 sets the nozzle 151 in the retreated state, and adjusts the height of the nozzle 151 so that the nozzle opening 152 is positioned below the tip of the brush of the contact member 244 of each cleaning member 240 and is positioned above the first cut section 291 and the second cut section 292 as shown in FIG. 12 in a state where each cleaning section 220 is positioned in the −Y direction of the nozzle 151.

In step S20, the control section 70 executes a first cutting process. In the first cutting process, the control section 70 controls the cleaning movement section 210 to cause the nozzle 151 to cross above the first cutting section 291 from a +Y direction side to a −Y direction side. At the time when step S20 is executed, the shaping material may hang down from the nozzle opening 152, for example, because the shaping material has been ejected from the nozzle 151 in the shaping process. The hanging shaping material is a waste material which does not contribute to the shaping of the three dimensional shaped object. By the first cutting process, the waste material hanging from the nozzle opening 152 can be cut and removed.

In step S30, the control section 70 executes a purging process. The purging process refers to a process of discharging a shaping material as a waste material from the nozzle 151 to a region different from the shaping region. In step S30, first, the control section 70 controls the cleaning movement section 210 to move the nozzle 151 in the −Y direction and position the nozzle 151 above the purge section 226. Next, the control section 70 controls the plasticizing section 12 and the ejection section 13 to discharge the shaping material as a waste material from the nozzle 151 to the purge section 226.

In step S40, the control section 70 executes a second cutting process. In the second cutting process, the control section 70 controls the cleaning movement section 210 to cause the nozzle 151 to cross above the second cutting section 292 from a +Z direction side to a −Z direction side. At the time when step S40 is executed, the waste material may hang down from the nozzle opening 152, because the waste material has been discharged from the nozzle 151 in the purging process. By the second cutting process, the waste material hanging from the nozzle opening 152 can be cut and removed.

In step S50, the control section 70 executes a cleaning operation by controlling the movement section 25. The cleaning operation is an operation of bringing the cleaning member 240 and the nozzle 151 into contact with each other while relatively reciprocating the nozzle 151 relative to the cleaning section 220 so that the nozzle 151 crosses the cleaning member 240 a plurality of times.

In FIG. 8 described above, a trajectory Lc of the movement of the nozzle opening 152 in the cleaning operation is shown. In the present embodiment, the trajectory Lc is not drawn by the nozzle opening 152 moving with respect to the cleaning section 220, but is drawn by the cleaning section 220 moving with respect to the nozzle opening 152. In the cleaning operation, the control section 70 controls the cleaning movement section 210 to move the nozzle opening 152 in the Y direction between a position P1 on a +Y direction side of the first cleaning member 241 and a position P2 on a −Y direction side of the second cleaning member 242. In the present embodiment, the first position P1 and the second position P2 overlap the cleaning box 222 when viewed in the Z direction. The nozzle opening 152 draws the same trajectory Lc in a forward path and a return path of the nozzle 151 in the cleaning operation. The forward path in the present embodiment is a path from the first position P1 to the second position P2. The return path is a path from the second position P2 to the first position P1. In FIG. 8, a movement direction D1 of the nozzle 151 in the forward path and the movement direction D2 of the nozzle 151 in the return path are indicated by arrows.

As shown in FIG. 8, in the present embodiment, the trajectory Lc passes through a position that does not overlap either rotation axis AX when viewed along the Z direction. Specifically, the trajectory Lc passes between the first rotation axis AX1 and the second rotation axis AX2 in the X direction, which is a direction intersecting the trajectory Lc. That is, in the present embodiment, it can be said that the rotation axis AX of each cleaning member 240 is arranged at a position that does not overlap the trajectory Lc when viewed along the Z direction. It can also be said that the first rotation axis AX1 and the second rotation axis AX2 are arranged such that the trajectory Lc passes between the first rotation axis AX1 and the second rotation axis AX2 in the X direction.

When the trajectory Lc passes between the first rotation axis AX1 and the second rotation axis AX2 as described above, a rotational force in the left direction is applied to the first cleaning member 241 and a rotational force in the right direction is applied to the second cleaning member 242 when viewed in the −Z direction due to the contact between each cleaning member 240 and the nozzle 151 in the forward path of the nozzle 151. As described above, in the present embodiment, rotation of each cleaning member 240 in the right direction is allowed, and rotation in the left direction is restricted. Therefore, the second cleaning member 242 is rotated in the right direction by the contact with the nozzle 151 in the forward path. On the other hand, the first cleaning member 241 does not rotate about the first rotation axis AX1 even when it comes into contact with the nozzle 151 in the forward path. On the contrary, a rotational force in the right direction is applied to the first cleaning member 241 and a rotational force in the left direction is applied to the second cleaning member 242 when viewed in the −Z direction due to the contact between each cleaning member 240 and the nozzle 151 in the return path of the nozzle 151. Therefore, in the return path, the first cleaning member 241 is rotated in the right direction by the contact with the nozzle 151. On the other hand, the second cleaning member 242 does not rotate about the second rotation axis AX2 even when it comes into contact with the nozzle 151 in the return path.

As shown in FIG. 8, in the present embodiment, a distance d1 between the trajectory Lc and the first rotation axis AX1 in the X direction and a distance d2 between the trajectory Lc and the second rotation axis AX2 in the X direction are different from each other. The distance d1 and the distance d2 represent the shortest distances between the rotation axes AX and the trajectory Lc. In the present embodiment, the distance d2 is shorter than the distance d1. That is, in the present embodiment, it can be said that the positional relationship in the X direction between each mount section 270 and the nozzle 151 is set so that the distance d2 is shorter than the distance d1. With this configuration, in the cleaning operation according to the present embodiment, the second cleaning member 242 comes into contact with the nozzle 151 in a region of the second contact member 246 where a distance from the second rotation axis AX2 is equal to or longer than the distance d2 when viewed in the Z direction. When viewed in the Z direction, the first cleaning member 241 comes into contact with the nozzle 151 in a region of the first contact member 245 where a distance from the first rotation axis AX1 is equal to or longer than the distance d1 when viewed in the Z direction. Therefore, the second contact member 246 can come into contact with the nozzle 151 in a wider range than the first contact member 245. Both the first contact member 245 and the second contact member 246 are in contact with the nozzle 151 in a region where a distance from the rotation axes AX are equal to or longer than the distance d1, but the contact angles of the nozzle 151 with respect to the contact members 244 in the region are different from each other.

In another embodiment, the cleaning process may be executed, for example, in addition to or instead of being executed during the shaping of the three dimensional shaped object, before ejection of the first shaping material for shaping the three dimensional shaped object is started, or after shaping of the three dimensional shaped object is completed. The cleaning process may be executed when a predetermined start operation is performed on the control section 70 by a user. For example, different cleaning processes may be executed between a cleaning process executed during the shaping of the three dimensional shaped object and a cleaning process executed other than during the shaping.

According to the three dimensional shaping device 100 of the present embodiment described above, the cleaning member 240 provided in the cleaning section 220 is configured to be rotatable about the rotation axis AX. The control section 70 controls the movement section 25 to execute the cleaning operation of bringing the cleaning member 240 and the nozzle 151 into contact with each other while reciprocating the nozzle 151 relative to the cleaning section 220 so that the nozzle 151 crosses the cleaning member 240 a plurality of times. In the cleaning operation, the nozzle 151 comes into contact with the cleaning member 240 at different positions in the forward path and the return path of the nozzle 151 by rotating the cleaning member 240 about the rotation axis AX. According to such a configuration, since the nozzle 151 is brought into contact with the cleaning member 240 at different positions in the forward path and the return path by the rotation of the cleaning member 240, it is possible to suppress the waste material clinging to the cleaning member 240 from being re-deposited on the nozzle 151. Therefore, it is possible to suppress the influence on shaping accuracy due to waste material clinging to the nozzle 151.

In the present embodiment, the restriction section 250 is provided which restricts the rotation of the cleaning member 240 about the rotation axis AX in one direction and allows the rotation in the other direction. Therefore, the nozzle 151 can be cleaned more strongly in a state where the rotation of the cleaning member 240 is restricted by the restriction section 250 in one of the forward path and the return path of the nozzle 151. In addition, in the other of the forward path and the return path, the cleaning member 240 can be rotated by the contact between the nozzle 151 and the cleaning member 240, and the nozzle 151 can be brought into contact with the cleaning member 240 at different positions on the forward path and the return path. In the next forward path, the nozzle 151 can be brought into contact with the cleaning member 240 at a position different from the contact position in the previous forward path.

In the present embodiment, the rotation axis AX of the cleaning member 240 is along the Z direction, and the rotation axis AX is arranged at a position that does not overlap the trajectory Lc of the nozzle opening 152 in the cleaning operation when viewed along the Z direction. The first rotation axis AX1 of the first cleaning member 241 and the second rotation axis AX2 of the second cleaning member 242 are arranged such that the trajectory Lc passes between the first rotation axis AX1 and the second rotation axis AX2 in the X direction. A direction in which the first cleaning member 241 is allowed to rotate and a direction in which the second cleaning member 242 is allowed to rotate are the same direction. Therefore, the nozzle 151 can be cleaned more strongly by either of the cleaning members 240 in both the forward path and the return path. In the cleaning operation, a front side of the nozzle 151 in a traveling direction of the nozzle 151 is easily cleaned more strongly. Therefore, by arranging the first rotation axis AX1 and the second rotation axis AX2 as described above, it is possible to effectively clean both sides along the traveling direction of the nozzle 151.

In the present embodiment, the distance d1 between the trajectory Lc and the first rotation axis AX1 is different from the distance d2 between the trajectory Lc and the second rotation axis AX2. According to such a configuration, for example, even when the cleaning members 240 are made of the same member, a region of one cleaning member 240 that can be in contact with the nozzle 151 and a region of the other cleaning member 240 that can be in contact with the nozzle 151 can be different from each other in the cleaning operation. Therefore, it is possible to easily differentiate a portion where one cleaning member 240 is easily worn and a portion where the other cleaning member 240 is easily worn in the cleaning operation. Therefore, for example, by interchanging the positions of one cleaning member 240 and the other cleaning member 240 after executing the cleaning operation a predetermined number of times, the life of each cleaning member 240 can be extended. In this case, such replacement of the arrangement positions may be executed, for example, every time the cleaning operation is executed a predetermined number of times.

In the present embodiment, the plate-shaped heating section 40 that heats the shaping region is positioned above the nozzle opening 152 and below the cleaning section 220 during shaping, and the control section 70 moves the heating section 40 and the cleaning section 220 relative to the stage 20 together with the ejection section 13 by controlling the movement section 25. According to such a configuration, since the heating section 40 is positioned below the cleaning section 220 at the time of shaping and the cleaning mechanism 60 is moved relative to the stage 20 together with the heating section 40, it is possible to heat the shaping region by the heating section 40 while suppressing the influence of heat by the heating section 40 on the cleaning section 220 during shaping. Since the cleaning section 220 moves relative to the stage 20 together with the ejection section 13, there is an increased possibility that a distance of the relative movement of the cleaning section 220 with respect to the nozzle 151, which is required to execute the cleaning operation, can be further shortened. According to the above embodiment, for example, while one nozzle 151 in the shaping state is shaping the shaped layer, the other nozzle 151 in the retreated state can be cleaned by the cleaning section 220 positioned above the heating section 40. In this way, it is possible to suppress the occurrence of a waiting time in which the three dimensional shaped object is not actually being shaped due to the cleaning of the nozzle 151 during shaping, and it is possible to shape the three dimensional shaped object more efficiently.

In the present embodiment, in the cleaning operation, the control section 70 controls the movement section 25 in a state where the nozzle opening 152 is positioned above the heating section 40 to move the cleaning section 220 with respect to the nozzle 151, thereby bringing the cleaning member 240 into contact with the nozzle 151. According to such a configuration, since the cleaning section 220 is moved with respect to the nozzle 151 in the cleaning operation, it is possible to suppress the waste material from falling unintentionally from the nozzle opening 152 as compared with the case where the nozzle 151 is moved with respect to the cleaning section 220.

In the present embodiment, the cleaning section 220 includes the purge section 226 that receives the waste material discharged from the nozzle 151, and the purge section 226 includes the openable and closable bottom surface 227. Therefore, the waste material can be received by the purge section 226 with the bottom surface 227 closed. By opening the bottom surface 227, the waste material received in the purge section 226 can be easily carried out to the outside of the purge section 226, so that the waste material can be suppressed from remaining in the purge section 226.

### B. Other Embodiments

(B-1) In the above embodiment, the cleaning member 240 is configured as a brush. On the other hand, the cleaning member 240 may not be configured as a brush, but may be configured as another member for cleaning the nozzle 151 by contact with the nozzle 151. In this case, the cleaning member 240 may be, for example, a flat plate-like member having no bristle or a wiping member made of a sponge. The flat plate-like member is also referred to as a flicker plate or a blade. A portion of the flat plate-like member that is in contact with the nozzle 151 may be provided with, for example, unevenness.

(B-2) In the above embodiment, a direction in which one of the cleaning members 240 is allowed to rotate and a direction in which the other cleaning member 240 is allowed to rotate are the same. On the other hand, directions in which the cleaning members 240 are allowed to rotate may be different from each other.

FIG. 13 is a view for explaining an example of arrangements of the cleaning members 240 in another embodiment. FIG. 13 schematically shows arrangements of the cleaning members 240 in substantially the same manner as FIG. 8. In FIG. 13, unlike FIG. 8, two cleaning members 240 are not arranged so that the trajectory Lc passes between the rotation axes AX. Specifically, in FIG. 13, the trajectory Lc passes by a +X direction side of each rotation axis AX. In the example of FIG. 13, the first cleaning member 241 is allowed to rotate in the right direction, as in FIG. 8, whereas the second cleaning member 242 is allowed to rotate in the left direction, unlike in FIG. 8. In this way, as in the first embodiment, the nozzle 151 can be cleaned more strongly by either of the cleaning members 240 in both the forward path and the return path. Also in FIG. 13, since the distance d2 and the distance d1 are different from each other as in FIG. 8, a portion where one cleaning member 240 is easily worn in the cleaning operation can be easily made different from a portion where the other cleaning member 240 is easily worn. In the arrangement shown in FIG. 13, the cleaning members 240 can be easily arranged in a space-saving manner in the X direction, as compared with the arrangement shown in FIG. 8. On the other hand, in the arrangement shown in FIG. 8, the cleaning members 240 can be easily arranged in a space-saving manner in the Y direction, as compared with the arrangement shown in FIG. 13.

For example, even when the cleaning members 240 are arranged as shown in FIG. 8, the restriction sections 250 may be configured such that the directions in which the cleaning members 240 are allowed to rotate are different from each other. Even when the cleaning members 240 are arranged as shown in FIG. 13, the restriction sections 250 may be configured such that the directions in which the cleaning members 240 are allowed to rotate are the same.

(B-3) In the above embodiment, the cleaning section 220 includes the restriction section 250. On the other hand, the cleaning section 220 may not include the restriction section 250. In this case, for example, the cleaning member 240 may be configured to rotate about the rotation axis AX under the control of the control section 70, and the control section 70 may rotate the cleaning member 240, so that the nozzle 151 is brought into contact with the cleaning member 240 at different positions in the forward path and the return path in the cleaning operation. The cleaning member 240 may be rotatable in one direction or the other direction about the rotation axis AX as long as the nozzles 151 come into contact with the cleaning member 240 at different positions in the forward path and the return path. In this case, for example, the amount of rotation of the cleaning member 240 about the rotation axis AX in one direction in the forward path may be made different from the amount of rotation about the rotation axis AX in the other direction in the return path.

(B-4) In the above embodiment, the distance d1 and the distance d2 are different from each other. On the other hand, the distance d1 and the distance d2 may be the same.

(B-5) In the above embodiment, the rotation axis AX is arranged along the Z direction which is the layering direction. On the other hand, the rotation axis AX may not be arranged along the layering direction. In this case, for example, the cleaning member 240 may be constituted by a roller-shaped member, and the cleaning member 240 may be arranged so that the rotation axis AX thereof intersects the layering direction and the trajectory Lc. Specifically, for example, the roller-shaped cleaning member 240 may be arranged such that the rotation axis AX extends along the X direction. In this case, the cleaning member 240 may be configured as, for example, a roll brush in which bristles are provided around a roller, or may be configured as a roller-shaped member having an uneven outer peripheral surface.

(B-6) In the above embodiment, the cleaning section 220 includes two cleaning members 240. On the other hand, the cleaning section 220 may include only one cleaning member 240, or may include three or more cleaning members 240. When two or more cleaning members 240 are provided, the cleaning members 240 may not be configured in the same manner. For example, the length of the bristles of the contact member 244 of one cleaning member 240 may be set to a length that can be in contact with the tip end section tp of the nozzle 151 from below, and the length of the bristles of the contact member 244 of the other cleaning member 240 may be longer than the length of the bristles of the contact member 244 of one cleaning member 240. In this way, the tip end section tp of the nozzle 151 can be cleaned more effectively by one cleaning member 240, and a portion above the tip end section tp of the nozzle 151 can be cleaned more effectively by the other cleaning member 240. For example, the materials of the contact members 244 may be different among the cleaning members 240.

(B-7) In the above embodiment, the heating section 40 may not be provided.

(B-8) In the above embodiment, the movement section 25 includes the position changing section 30, the head raising/lowering mechanism 50, and the cleaning movement section 210. On the other hand, as long as the movement section 25 is configured to be able to execute the cleaning operation by changing the relative positions of the ejection section 13, the stage 20, and the cleaning section 220, the movement section 25 may not include a part or all of the components described above. For example, instead of the cleaning movement section 210, the movement section 25 may include a moving mechanism that moves the nozzle 151 in the horizontal direction with respect to the cleaning section 220. In this case, the control section 70 may control the moving mechanism to move the nozzle 151 with respect to the cleaning section 220, thereby bringing the nozzle 151 into contact with the cleaning member 240. For example, in a configuration in which the cleaning section 220 is arranged below the heating section 40 or in a configuration in which the heating section 40 is not provided, a moving mechanism that moves the cleaning section 220 in the Z direction with respect to the nozzle 151 may be provided instead of the head raising/lowering mechanism 50. For example, the cleaning mechanism 60 may not be configured to move relative to the stage 20 together with the ejection section 13, and in this case, the control section 70 may execute the cleaning operation by controlling only the position changing section 30.

(B-9) In the above embodiment, the bottom surface 227 of the purge section 226 is configured to be opened by the contact between the slide member 228 and the waste material accommodation section 230. On the other hand, an opening and closing operation of the bottom surface 227 may be controlled, for example, by the control section 70. In this case, for example, the bottom surface 227 may be opened and closed by connecting the slide member 228 to an electric actuator and operating the slide member 228 by the electric actuator under the control of the control section 70. In this case, when the waste material is discharged from the purge section 226 to the waste material accommodation section 230, the control section 70 may open the bottom surface 227 by controlling the electric actuator after the purge section 226 is moved to a position above the waste material accommodation section 230 by the cleaning movement section 210, for example. The bottom surface 227 may not be opened and closed by an operation of the slide member 228, and for example, may be configured to be opened and closed by changing an inclination angle of the bottom surface 227 with respect to the horizontal direction. Also in this case, the bottom surface 227 may be configured to be opened, for example, by contact between a mechanism for changing the inclination angle of the bottom surface 227 and the waste material accommodation section 230, or an opening and closing operation of the bottom surface 227 may be controlled by the control section 70.

(B-10) In the above embodiment, the bottom surface 227 of the purge section 226 is configured to be openable and closable, but may not be configured to be openable and closable. The cleaning section 220 may not include the purge section 226.

(B-11) In the above embodiment, two cleaning sections 220 are provided corresponding to the first nozzle 151a and the second nozzle 151b, but the number of the cleaning sections 220 may not correspond to the number of the nozzles 151 and the heads 10. For example, only one cleaning section 220 may be provided, and the first nozzle 151a and the second nozzle 151b may be cleaned by that cleaning section 220.

(B-12) The three dimensional shaping device 100 of the embodiment described above includes two heads 10, but the three dimensional shaping device 100 may include only one head 10, or may include three or more heads 10.

(B-13) In the above embodiment, the plasticizing section 12 provided in the head 10 plasticizes the material by a flat screw. On the other hand, the plasticizing section 12 may be configured to plasticize the material by rotating an in-line screw, for example. The plasticizing section 12 may be configured to plasticize the filament-shaped material with a heater. In the above-described embodiment, the material extrusion method of layering the plasticized material has been described as an example, but the present disclosure can be applied to various methods such as an inkjet method, a direct metal deposition (DMD) method, and a binder jet method.

### C. Other Forms

The present disclosure is not limited to the embodiments described above, and can be realized in various forms without departing from the scope of the present disclosure. For example, the present disclosure can also be realized by the following forms. The technical features in the above-described embodiments corresponding to the technical features in each form described below can be appropriately replaced or combined in order to solve a part or all of the problems of the present disclosure or to achieve a part or all of the effects of the present disclosure. In addition, unless the technical features are described as essential in the present specification, the technical features can be appropriately deleted.

(1) According to one aspect of the present disclosure, a three dimensional shaping device is provided.

The three dimensional shaping device includes an ejection section that includes a nozzle having a nozzle opening and that is configured to eject a shaping material from the nozzle opening; a stage on which the shaping material is layered; a cleaning section including at least one cleaning member that rotates about a rotation axis; a movement section configured to change relative positions of the ejection section, the stage, and the cleaning section; and a control section.

The control section controls the movement section to execute a cleaning operation of bringing the cleaning member and the nozzle into contact with each other while reciprocating the nozzle relative to the cleaning section so that the nozzle passes across the cleaning member a plurality of times.

In the cleaning operation, the nozzle comes into contact with the cleaning member at different positions in a forward path and a return path of the nozzle by rotating the cleaning member.

According to this aspect, since the nozzle is brought into contact with the cleaning member at different positions in the forward path and the return path in the cleaning operation by the rotation of the cleaning member, it is possible to suppress the waste material clinging to the cleaning member from being re-deposited on the nozzle. Therefore, it is possible to suppress the influence on shaping accuracy due to waste material clinging to the nozzle.

(2) The above aspect may be configured such that the cleaning section includes a restriction section that restricts rotation of the cleaning member in one direction about the rotation axis and allows rotation in the other direction.

According to such an aspect, the nozzle can be cleaned more strongly in a state where the rotation of the cleaning member is restricted by the restriction section in one of the forward path and the return path of the nozzle. In addition, in the other of the forward path and the return path, the cleaning member can be rotated by the contact between the nozzle and the cleaning member, and the nozzle can be brought into contact with the cleaning member at different positions on the forward path and the return path.

(3) The above aspect may be configured such that the rotation axis extends in a layering direction of the shaping material, the rotation axis is arranged at a position that does not overlap a trajectory of the nozzle opening in the cleaning operation when viewed along the layering direction, the cleaning section includes two cleaning members, a first rotation axis, which is the rotation axis of one of the cleaning members, and a second rotation axis, which is the rotation axis of the other cleaning member, are arranged in a direction intersecting the trajectory so that the trajectory passes between the first rotation axis and the second rotation axis, and a direction in which one of the cleaning members is allowed to rotate and a direction in which the other cleaning member is allowed to rotate are the same direction.

According to such an aspect, the nozzle can be cleaned more strongly by either of the cleaning members in both the forward path and the return path.

(4) The above aspect may be configured such that the rotation axis of the cleaning member extends in a layering direction of the shaping material, the rotation axis is arranged at a position that does not overlap a trajectory of the nozzle opening in the cleaning operation when viewed along the layering direction, the cleaning section includes two of the cleaning members, and as viewed along the layering direction, the shortest distance between the rotation axis of one of the cleaning members and the trajectory is different from the shortest distance between the rotation axis of the other cleaning member and the trajectory.

According to such an aspect, for example, even when the cleaning members are made of the same member, a region of one cleaning member that can be in contact with the nozzle and a region of the other cleaning member that can be in contact with the nozzle can be different from each other in the cleaning operation. Therefore, it is possible to easily differentiate a portion where one cleaning member is easily worn and a portion where the other cleaning member is easily worn in the cleaning operation.

(5) The above aspect may be configured such that the three dimensional shaping device includes a heating section which has a plate shape and configured to heat a shaping region of the stage, the heating section is positioned above the nozzle opening and below the cleaning section during shaping, and the control section moves the heating section and the cleaning section together with the ejection section relative to the stage by controlling the movement section.

According to such an aspect, since the heating section is positioned below the cleaning section at the time of shaping and the cleaning section is moved relative to the stage together with the heating section, it is possible to heat the shaping region by the heating section while suppressing the influence of heat by the heating section on the cleaning section during shaping. Since the cleaning section moves relative to the stage together with the ejection section, there is an increased possibility that a distance of the relative movement of the cleaning section with respect to the nozzle, which is required to execute the cleaning operation, can be further shortened.

(6) The above aspect may be configured such that in the cleaning operation, the control section controls the movement section to position the nozzle opening above the heating section, and moves the cleaning section with respect to the nozzle to bring the cleaning member into contact with the nozzle.

According to such an aspect, since the cleaning section is moved with respect to the nozzle in the cleaning operation, it is possible to suppress the waste material from falling unintentionally from the nozzle opening as compared with the case where the nozzle is moved with respect to the cleaning section.

(7) The above aspect may be configured such that the cleaning section includes a purge section that receives a waste material discharged from the nozzle and the purge section includes a bottom surface configured to open and close.

According to such an aspect, the waste material can be received by the purge section with the bottom surface closed. By opening the bottom surface, the waste material received in the purge section can be easily carried out to the outside of the purge section, so that the waste material can be suppressed from remaining in the purge section.

What is claimed is:

1. A three dimensional shaping device comprising:
an ejection section that includes a nozzle having a nozzle opening and that is configured to eject a shaping material from the nozzle opening;
a stage on which the shaping material is layered;
a cleaning section including at least one cleaning member that rotates about a rotation axis;
a movement section configured to change relative positions of the ejection section, the stage, and the cleaning section; and
a control section, wherein
the control section controls the movement section to execute a cleaning operation of bringing the cleaning member and the nozzle into contact with each other while reciprocating the nozzle relative to the cleaning section so that the nozzle passes across the cleaning member a plurality of times and
in the cleaning operation, the nozzle comes into contact with the cleaning member at different positions in a forward path and a return path of the nozzle by rotating the cleaning member about the rotation axis.

2. The three dimensional shaping device according to claim 1, wherein
the cleaning section includes a restriction section that restricts rotation of the cleaning member in one direction about the rotation axis and allows rotation in the other direction.

3. The three dimensional shaping device according to claim 2, wherein
the rotation axis extends in a layering direction of the shaping material,
the rotation axis is arranged at a position that does not overlap a trajectory of the nozzle opening in the cleaning operation when viewed along the layering direction,
the cleaning section includes two cleaning members,
a first rotation axis, which is the rotation axis of one of the cleaning members, and a second rotation axis, which is the rotation axis of the other cleaning member, are arranged in a direction intersecting the trajectory so that the trajectory passes between the first rotation axis and the second rotation axis, and
a direction in which one of the cleaning members is allowed to rotate and a direction in which the other cleaning member is allowed to rotate are the same direction.

4. The three dimensional shaping device according to claim 1, wherein
the rotation axis of the cleaning member extends in a layering direction of the shaping material,
the rotation axis is arranged at a position that does not overlap a trajectory of the nozzle opening in the cleaning operation when viewed along the layering direction,
the cleaning section includes two of the cleaning members, and
as viewed along the layering direction, the shortest distance between the rotation axis of one of the cleaning members and the trajectory is different from the shortest distance between the rotation axis of the other cleaning member and the trajectory.

5. The three dimensional shaping device according to claim 1, further comprising:
a heating section that has a plate shape and that is configured to heat a shaping region of the stage, wherein
the heating section is positioned above the nozzle opening and below the cleaning section during shaping and
the control section moves the heating section and the cleaning section together with the ejection section relative to the stage by controlling the movement section.

6. The three dimensional shaping device according to claim 5, wherein
in the cleaning operation, the control section controls the movement section to position the nozzle opening above the heating section, and moves the cleaning section with respect to the nozzle to bring the cleaning member into contact with the nozzle.

7. The three dimensional shaping device according to claim 5, wherein
the cleaning section includes a purge section that receives a waste material discharged from the nozzle and
the purge section includes a bottom surface configured to open and close.
